(19) United States
(12) Patent Application Publication
(10) Pub. No.: US 2014/0198672 A1
(43) Pub. Date: Jul. 17, 2014

(54) WAITING TIME PARAMETER FOR IN-DEVICE COEXISTENCE INTERFERENCE SOLUTION

(71) Applicant: RESEARCH IN MOTION LIMITED, Waterloo (CA)

(72) Inventors: Changhoi Koo, Plano, TX (US); Jun Li, Richardson, TX (US); Zhijun Cai, Euless, TX (US)

(73) Assignee: RESEARCH IN MOTION LIMITED, Waterloo (CA)

(21) Appl. No.: 13/742,419

(22) Filed: Jan. 16, 2013

(51) Int. Cl. H04W 72/04

(52) U.S. Cl. CPC H04W 72/042
USPC 370/252; 370/329

(57) ABSTRACT

A user equipment receives, from a wireless access network node, a waiting time parameter indicating an amount of waiting time relating to provision, by the wireless access network node, of a solution for in-device coexistence (IDC) interference at the user equipment.

### BACKGROUND

A user equipment (UE) can include multiple wireless interfaces (e.g. wireless interfaces capable of performing radio frequency (RF) communications). The presence of multiple wireless interfaces allows the UE to communicate content using any of several different communications links. Examples of wireless interfaces that may be present in a UE include a wireless interface to communicate in a Long Term Evolution (LTE) frequency band, a wireless interface to communicate in an Industrial Scientific Medical (ISM) frequency band, or a wireless interface to communicate in a Global Navigation Satellite System (GNSS) frequency band.

### BRIEF DESCRIPTION OF THE DRAWINGS

Some embodiments are described with respect to the following figures.

FIG. 1 is a schematic diagram of various phases of an example operation in response to detection of in-device coexistence (IDC) interference.

FIG. 2 is a message flow diagram of a process relating to setting a waiting time parameter for IDC interference management, in accordance with some implementations.

FIGS. 3 and 4 are schematic diagrams of tasks of a user equipment and a wireless access network node for IDC interference management, according to some examples.

FIGS. 5 and 6 are flow diagrams of processes of a user equipment for IDC interference management, in accordance with some implementations.

FIG. 7 is a block diagram of an example arrangement that includes a user equipment and wireless access network nodes, in accordance with some implementations.

FIG. 8 is a block diagram of an example system that incorporates some implementations.

### DETAILED DESCRIPTION

The presence of multiple types of wireless interfaces (that are capable of performing wireless communications according to different wireless technologies) in a user equipment (UE) can result in interference between the different wireless interfaces. In some implementations, the different wireless interfaces may operate concurrently in adjacent or overlapping radio frequency (RF) bands. In the ensuing discussion, a wireless interface that communicates in an RF band is also referred to as a radio interface. Note that although reference is made to radio interfaces in the ensuing discussion, it is noted that techniques or mechanisms can also be applied to other types of wireless interfaces, such as interfaces that communicate at frequencies outside the RF bands, interfaces that communicate optically (e.g. infrared interfaces), interfaces that communicate using acoustic signaling, and so forth.

If multiple radio interfaces in a UE are able to operate concurrently in adjacent or overlapping frequency bands, then signal transmission in a first frequency band by one radio interface in the UE can interfere with signal reception in a second frequency band by another radio interface in the same UE, particularly where the radio interfaces are in relatively close proximity to each other in the UE. Such interference can be referred to as in-device coexistence (IDC) interference. In some examples, IDC interference can occur between a radio interface operating according to the Long Term Evolution (LTE) technology and another radio interface operating according to the Industrial, Scientific and Medical (ISM) technology.

The LTE technology is defined by LTE standards provided by the Third Generation Partnership Project (3GPP). The LTE standards include the initial LTE standards or the LTE-Advanced standards. The LTE standards are also referred to as the Evolved Universal Terrestrial Radio Access (EUTRA) standards.

The frequency band for the ISM technology is reserved for use of certain types of communications, such as Bluetooth communications, WiFi communications, and so forth. The ISM technology is defined by the International Telecommunication Union (ITU).

IDC interference can also exist between an LTE radio interface and another radio interface that performs Global Navigation Satellite Systems (GNSS) communications. An example of a radio interface that performs GNSS communications is a radio interface in a Global Positioning System (GPS) receiver.

Although reference is made to IDC interference between specific example radio interfaces, it is noted that techniques or mechanisms according to some implementations are applicable to address IDC interference between other types of wireless technologies.

In response to detection of IDC interference in a UE that satisfies a triggering condition, the UE can send an IDC indication to a corresponding wireless access network node. In the context of LTE, the wireless access network node can be an enhanced Node B (eNB). Generally, an “IDC indication” includes any information that relates to IDC interference, which can be provided in any of various possible messages that can be sent from a UE to the corresponding wireless access network node.

In some implementations, the triggering condition for triggering transmission of an IDC indication can include a specification of an IDC interference threshold. An IDC interference threshold can refer to a threshold that is used for mitigating (reducing or removing) IDC interference. If IDC interference exceeds the IDC interference threshold, then an IDC indication may be triggered for transmission from the UE to the wireless access network node.

A wireless access network node can send an IDC solution to the UE in response to an IDC indication from the UE that indicates presence of IDC interference. The IDC solution causes the UE to modify its wireless communication behavior to remove or reduce the IDC interference.

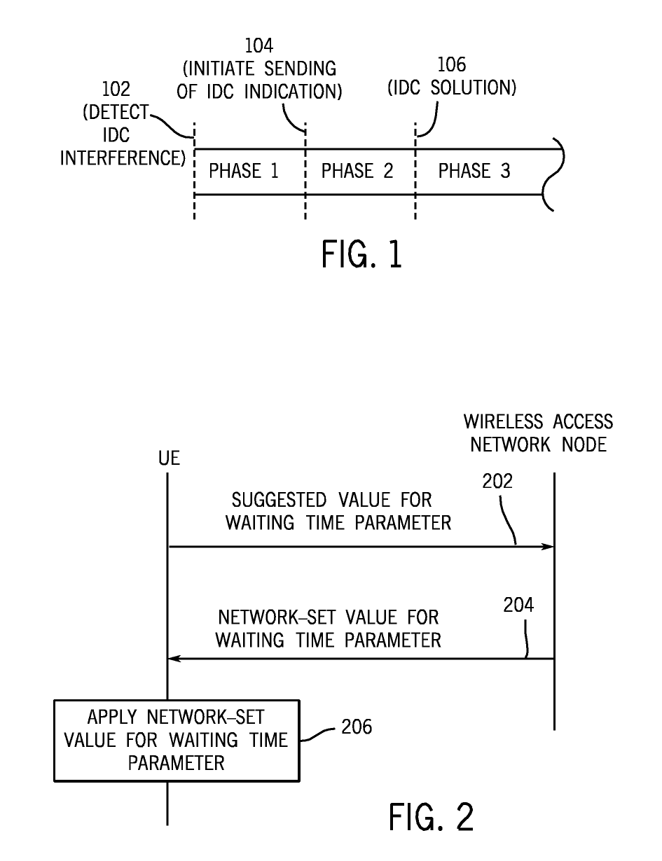

FIG. 1 shows an example of several phases that may be involved in an IDC interference-related operation. Phase 1 is started when the UE detects (at 102) IDC interference (that exceeds the IDC interference threshold). In response to this detection, the UE initiates (at 104) the sending of an IDC indication to a wireless access network node serving the UE, which starts phase 2. After sending the IDC indication, the UE waits for an IDC solution from the wireless access network node. If the wireless access network node sends (at 106) an IDC solution in response to the IDC indication, then phase 3 is started as depicted in FIG. 1. The UE applies the IDC solution in phase 3.

In some cases, the wireless access network node (e.g. eNB) may only have the authority to make a decision regarding what IDC solution is to be allocated to the UE based on the IDC indication from the UE; the wireless access network node may not be able to indicate that no IDC solution will be offered. It may be possible that the wireless access network node does not accept the IDC request from the UE due to various issues, such as issues relating to scheduling, load balancing, inadequate available resource, interference coordination, and so forth. Accordingly, if the wireless access network node does not indicate that there is no available IDC solution for the UE, the UE may spend a relatively long period of time waiting for the IDC solution.

Waiting an excessive amount of time to receive an IDC solution may result in a degraded quality-of-service (QoS) level to a first wireless interface (e.g. an ISM interface or GNSS interface) because the UE has to perform autonomous denial while waiting for an IDC solution from the wireless access network node to be received by a second wireless interface (e.g. LTE interface). Autonomous denial involves the UE ignoring uplink transmissions at the first wireless interface while the UE is waiting for receipt of the IDC solution (sent in a downlink transmission) at the second wireless interface. Performing autonomous denial and continually monitoring for downlink signaling pertaining to the IDC solution (during phase 2 in FIG. 1) may also be wasteful of power at the UE. Also, if the IDC solution was never received, then the UE would have just wasted the time spent waiting for the IDC solution.

In some cases, the UE may be configured with an implementation-specific waiting timer, which is pre-configured at the UE according to manufacturer settings. The implementation-specific waiting timer can be started when the UE initiates (at 104) the sending of the IDC indication. If the implementation-specific waiting timer expires before the UE receives an IDC solution, then the UE may declare a radio link failure (RLF) and start RLF-related operations, such as be selecting or reselecting another cell. However, since the implementation-specific waiting timer is configured at the UE and not by the network, different UEs may employ different implementation-specific waiting timer values, while other UEs may not include implementation-specific waiting timers at all. This can lead to vague and unpredictable behavior at UEs in response to IDC interference.

In some cases, a UE may include a prohibit mechanism that has a prohibit timer. The prohibit timer can be used to define a minimum time interval between successive transmissions of IDC indications by the UE. The UE may include the prohibit mechanism in addition to the implementation-specific waiting timer; alternatively, the UE may include the prohibit mechanism but not an implementation-specific waiting timer. In other cases, the UE may not include a prohibit mechanism.

The presence of the prohibit timer in the UE may pose additional issues. If the prohibit timer time duration is set relatively high (which results in a longer time interval between transmissions of IDC indications), that may force the UE to wait the length of time specified by the prohibit timer before the UE can send another IDC indication. Thus, if the time duration of the prohibit timer time is longer than the time duration of the implementation-specific waiting timer, then the UE may have to wait an even longer period of time for an IDC solution after the implementation-specific waiting timer has expired, since the UE would not be able to re-transmit an IDC indication until expiration of the prohibit timer.

On the other hand, it may not be desirable to set the time duration of the prohibit timer too short, since that may result in excessive transmissions of IDC indications, which increases network signaling overhead.

The issue is exacerbated further since implementation of a prohibit mechanism may be left to the UE manufacturers. As a result, inconsistent behavior may result due to different implementations of prohibit mechanisms at different UEs. Since both prohibit mechanisms and implementation-specific waiting timers are left to implementation choices made by UE manufacturers, a network would be unable to control the behavior of UEs in responding to presence of IDC interference.

In accordance with some implementations, an extended waiting timer that can be allocated by a wireless access network node is provided. The extended waiting timer can be represented by a waiting time parameter that can be sent from the wireless access network node to the UE. The waiting time parameter indicates an amount of time relating to provision, by the wireless access network node, of an IDC solution for IDC interference at the UE. The waiting time parameter can indicate an amount of time that the wireless access network node may take to possibly provide an IDC solution.

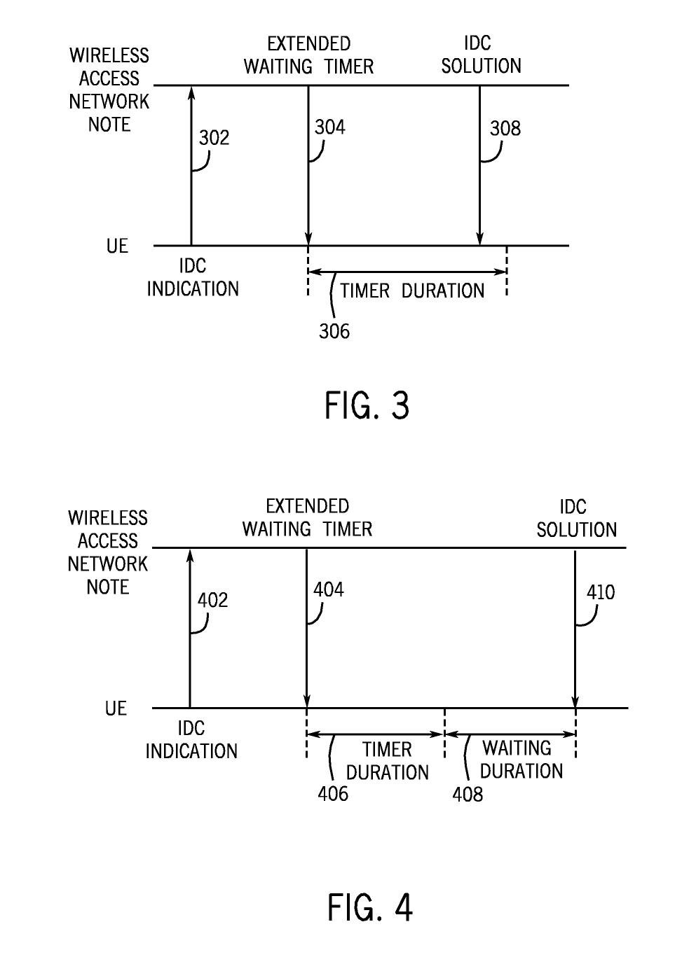

FIG. 2 is a message flow diagram of a process according to some implementations. The UE can send (at 202), to the wireless access network node, a suggested value for the waiting time parameter that represents the extended waiting timer. The suggested value for the waiting time parameter can be based on one or more of the following factors: loading at the UE, traffic condition at the UE (e.g. type of traffic, such as voice traffic, data traffic, etc.), interference status at the UE (e.g. severity level of IDC interference), and so forth.

In response to the suggested value for the waiting time parameter, the wireless access network node sends (at 204) a network-set value for the waiting time parameter. The network-set value for the waiting time parameter can be different from or the same as the suggested value for the waiting time parameter provided by the UE. In some examples, the wireless access network node can generate the network-set value for the waiting time parameter based on the suggested value received from the UE.

In other implementations, the UE may not send a suggested value for the waiting time parameter. In such implementations, the wireless access network node may send (at 204) the network-set value for the waiting time parameter in response to other events, such as in response to an IDC indication from the UE, or whenever some predetermined message is to be sent by the wireless access network node. More generally, the wireless access network node can send the network-set value for the waiting time parameter either in response to a request or other information from the UE, or in an un-solicited manner (i.e. the wireless access network node sends the network-set value for the waiting time parameter without prompting from the UE).

The network-set value for the waiting time parameter can be applied (at 206) by the UE, either immediately upon receipt or after some activation duration.

The extended waiting timer can represent either (1) the longest time duration that the wireless access network node would take to allocate an IDC solution in response to an IDC indication, or (2) the shortest time duration that the wireless access network node would take to allocate an IDC solution in response to an IDC indication.

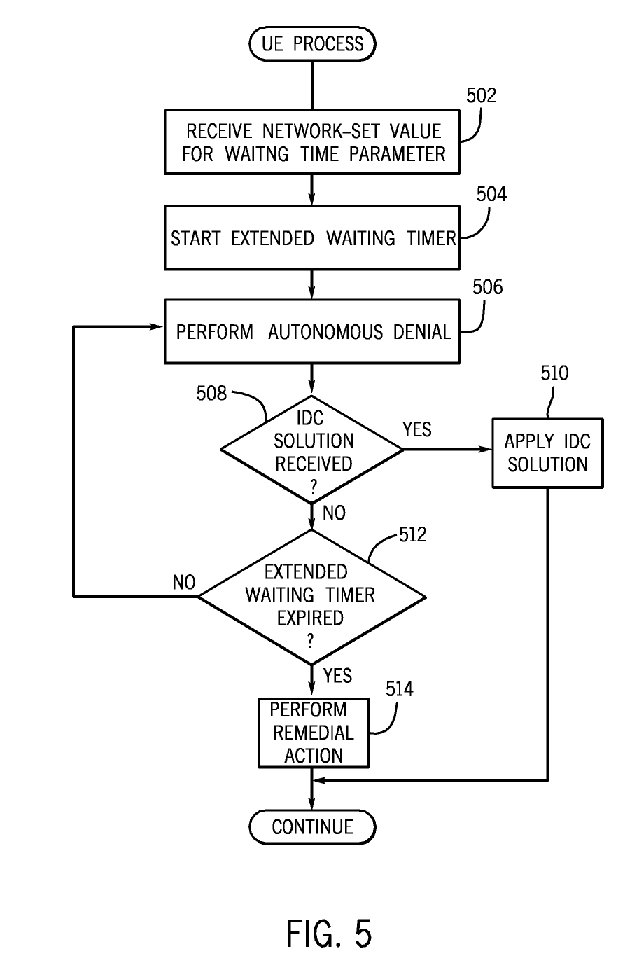

With alternative (1) above, the extended waiting timer represents the maximum time duration that the UE would have to suffer IDC interference while waiting for an IDC solution from the wireless access network node. FIG. 3 is a schematic diagram of an example operation using the extended waiting timer according to alternative (1). Upon detecting IDC interference that exceeds the IDC interference threshold, the UE sends (at 302) an IDC indication to the wireless access network node. In response to the IDC indication, the wireless access network node sends (at 304), to the UE, the network-set value for the waiting time parameter that represents the extended waiting timer.

The time duration to be counted by the extended waiting timer is represented as 306 in FIG. 3. During the time duration 306, the UE waits for the IDC solution from the wireless access network node, and the UE may perform autonomous denial. For example, if the UE is waiting for downlink signaling that includes the IDC solution at the LTE interface, the UE may perform autonomous denial at the ISM or GNSS interface to ignore uplink transmissions at the ISM or GNSS interface. FIG. 3 shows that the IDC solution is sent (at 308) by the wireless access network node to the UE prior to expiration of the time duration 306 of the extended waiting timer.

With alternative (2) above, the extended waiting timer would indicate an initial time duration (minimum time duration) that the UE is expected to experience IDC interference while waiting for an IDC solution from the wireless access network node. FIG. 4 is a schematic diagram of an example operation using the extended waiting timer according to alternative (2). Upon detecting IDC interference that exceeds the IDC interference threshold, the UE sends (at 402) an IDC indication to the wireless access network node. In response to the IDC indication, the wireless access network node sends (at 404), to the UE, the network-set value for the waiting time parameter that represents the extended waiting timer. The time duration over which the extended waiting timer is to count is represented as 406 in FIG. 4. During the time duration 406, the UE does not perform autonomous denial, since it is not expected that the wireless access network node would send an IDC solution prior to expiration of the extended waiting timer according to alternative (2).

However, after expiration of the extended waiting timer (after the end of the time duration 406), another waiting duration 408 (that is immediately after the time duration 406) is depicted in FIG. 4. The waiting duration 408 is the duration immediately after expiration the extended waiting timer and prior to receipt (at 410) of an IDC solution from the wireless access network node. During the waiting duration 408, the UE waits for the IDC solution from the wireless access network node, and the UE may perform autonomous denial.

The suggested value for the waiting time parameter that can be sent (at 202) in FIG. 2 can be in any of the following messages:
A new uplink Radio Resource Control (RRC) message sent from the UE to the wireless access network node. An RRC message is a message sent by an RRC layer in a wireless node such as a UE or wireless access network node. A new RRC message is an RRC message that is not defined in current wireless standards, such as the 3GPP Technical Specification (TS) TS 36.331. However, the new RRC message may be incorporated into a later version of the wireless standard.
A new information element in an existing uplink RRC message (e.g. IDC indication message). A new information element in the existing RRC message is an information element not defined in current wireless standards, although it may be incorporated into a later version of the wireless standard.
A physical level signal on a Physical Uplink Control Channel (PUCCH), where the physical level signal is a signal of a physical layer without information from a higher protocol layer.
A new uplink Medium Access Control (MAC) control element. A new uplink MAC control element is a MAC control element that is not defined in current wireless standards.
A reservation field of an existing MAC control element. A reservation field is a field in the existing MAC control element that is reserved for other purposes.

The wireless access network node can set the value for the waiting time parameter (to be sent at 204 in FIG. 2) using one of several techniques.

In a first technique, the waiting time parameter is configurable, and can be set by the wireless access network node based on one or more of the following conditions at the wireless access network node: resource scheduling status, load balancing status, and so forth. The value of the waiting time parameter for different UEs can be set to be different by the wireless access network node. For example, the value of the waiting time parameter for a first UE may be set by the wireless access network node to be different from the value of the waiting time parameter for a second UE.

In a second alternative technique, the value of the waiting time parameter may be fixed. In some examples, the fixed value of the waiting time parameter may be sent in a message by the wireless access network node to the UE. In one example, the message can be a dedicated RRC message sent from the wireless access network node to the UE during an initial connection stage (e.g. RRC connection establishment stage). In another example, the message can be a broadcast message (sent to multiple UEs) that is sent in a broadcast channel.

As another alternative, the fixed value does not have to be signaled from the wireless access network node to the UE. Instead, the fixed value of the waiting time parameter that represents the extended waiting timer can be included in a system parameter defined by a standard, such as an LTE standard. UEs that operate according to this standard would use the fixed value for the extended waiting timer defined by the standard. In this way, even though the network does not signal the value for the extended waiting timer to UEs, the UEs would nevertheless use a value that is known to the network (instead of values of implementation-specific timers that may vary between UE manufacturers and may not be known to the network).

In some implementations, if the wireless access network node decided that it does not plan to allocate any IDC solution to the UE in response to an IDC indication, the wireless access network node can send (at 204 in FIG. 2) a value of zero (or some other pre-specified value) for the waiting time parameter. A value of zero, or some other pre-specified value, represents an IDC request rejection message to the UE.

In implementations where the wireless access network node sends a network-set value for the waiting time parameter to the UE, this waiting time parameter can be included in any of the following messages:
A new downlink RRC message.
A new information element of an existing downlink RRC message (e.g. RRCConnectionReconfiguration message).
A new MAC control element.
A reservation field of an existing MAC control element.

In some implementations, after the wireless access network node has sent (at 204 in FIG. 2) the network-set value for the waiting time parameter, the wireless access network node can update the value for the waiting time parameter if the wireless access network node is unable to allocate an IDC solution within the time duration indicated by the value for the waiting time parameter for any reason, such as due to scheduling issue, load balancing issue, and so forth. The updated value for the waiting time parameter can be sent by the wireless access network node to the UE prior to expiration of the extended waiting timer at the UE based on the previously set value for the waiting time parameter.

The updated value for the waiting time parameter can be sent using any of the following messages:
A new downlink RRC message.
A new information element of existing RRC message.
A new MAC control element.
A reservation field of an existing MAC control element.

The updated value may be applied immediately by the UE upon receipt or after some activation duration.

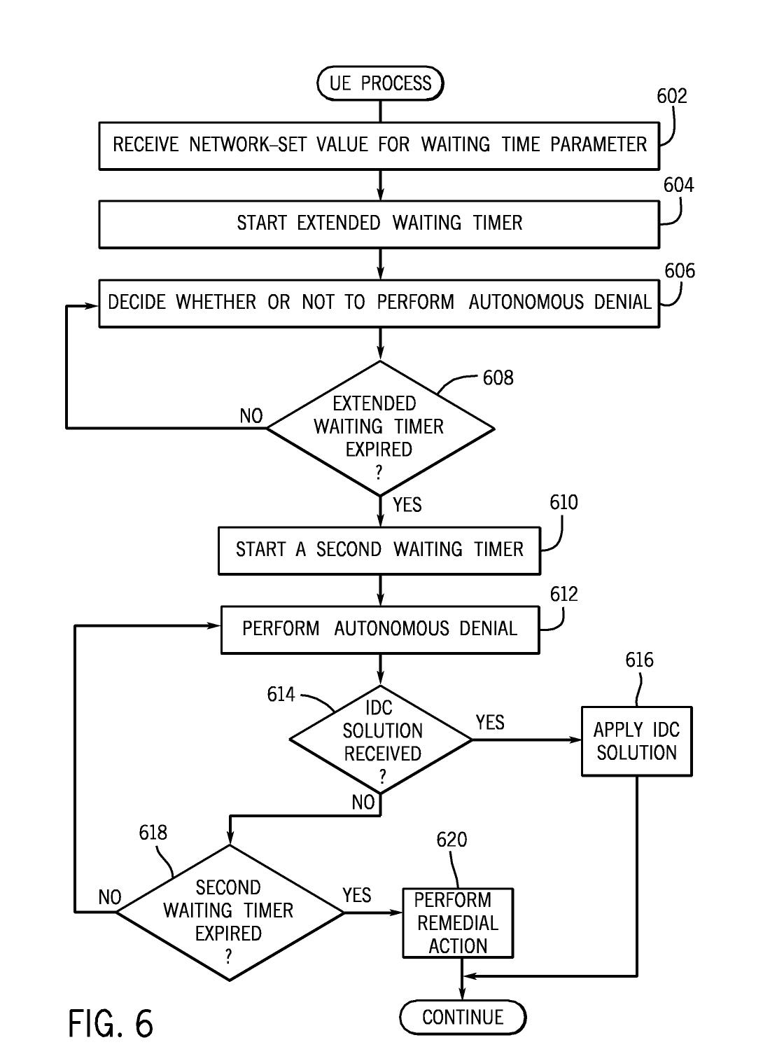

FIGS. 5 and 6 are flow diagrams of UE processes illustrating UE behavior associated with the extended waiting timer according to some implementations. FIG. 5 relates to alternative (1) where the extended waiting timer represents the longest time duration that the wireless access network node would take to allocate an IDC solution in response to an IDC indication. FIG. 6 relates to alternative (2) where the extended waiting timer represents the shortest time duration that the wireless access network node would take to allocate an IDC solution in response to an IDC indication.

In FIG. 5, the UE receives (at 502) the network-set value for the waiting time parameter. The UE then applies the network-set value and starts (at 504) the extended waiting timer in the UE. The extended waiting timer can be an incrementing timer or a decrementing timer. If an incrementing timer, the extended waiting timer starts from an initial value (e.g. zero) and counts up to the network-set value for the waiting time parameter. If a decrementing timer, the extended waiting timer starts from the network-set value and decrements down to an expiration value (e.g. zero).

With alternative (1), the wireless access network node should allocate an IDC solution prior to expiration of the extended waiting timer. While the extended waiting timer is counting and prior to expiration of the extended waiting timer, the UE performs (at 506) autonomous denial (since the wireless access network node may allocate an IDC solution during the duration counted by the extended waiting timer). The time duration of the extended waiting timer is depicted as 306 in FIG. 3.

The UE next determines (at 508) if an IDC solution has been received from the wireless access network node. If so, the UE applies (at 510) the IDC solution. On the other hand, if the IDC solution has not been received, the UE determines (at 512) if the extended waiting timer has expired. If not, the process returns to task 506. However, if the extended waiting timer has expired, then the UE performs (at 514) a remedial action due to failure to receive the IDC solution. The UE can declare a radio link failure (RLF) and perform an RLF-related operation, which can include cell reselection. Alternatively, the UE can send another IDC indication to the wireless access network node.

In implementations where the UE declares RLF, the RLF can be declared after expiration of an RLF timer (e.g. T310 timer as set by a wireless access node). In some implementations, the duration of the extended waiting timer can be included in the duration of the RLF timer. In this case, the RLF timer can be started at the same time as the extended waiting timer. Assuming that the RLF timer has a longer duration than the extended waiting timer, the RLF timer continues to count after expiration of the extended waiting timer. Once the RLF timer expires, the RLF can be declared by the UE. In a specific example, it is assumed that the RLF timer duration is 1 second (sec), and the extended waiting timer duration is 400 milliseconds (ms). After expiration of the extended waiting timer (400 ms has elapsed), the RLF timer would continue to count another 600 ms (for a total of 1 sec) before expiration.

In alternative implementations, the duration of the extended waiting timer is not included in the duration of the RLF timer. In this case, the RLF timer can be started after expiration of the extended waiting timer. In the specific example discussed above, it is assumed that the RLF timer duration is 1 second (sec), and the extended waiting timer duration is 400 milliseconds (ms). After expiration of the extended waiting timer (i.e. 400 ms has elapsed), the RLF timer would then start and count another 1 sec before expiration, at which point the UE can declare an RLF. In these alternative implementations, the UE would wait 1.4 sec before declaring an RLF, rather than just 1 sec as in the above implementations.

The wireless access network node can indicate to the UE whether or not the duration of the extended waiting timer is to be included in the duration of the RLF timer. If the duration of the extended waiting timer is to be included in the duration of the RLF timer, then the extended waiting timer and the RLF timer are to run concurrently. However, if the duration of the extended waiting timer is not to be included in the duration of the RLF timer, then the RLF timer starts running after expiration of the extended waiting timer.

In FIG. 6, the UE receives (at 602) the network-set value for the waiting time parameter. The UE then applies the network-set value and starts (at 604) the extended waiting timer in the UE.

With alternative (2), the wireless access network node would not allocate an IDC solution prior to expiration of the extended waiting timer. Thus, while the extended waiting timer is counting and prior to expiration of the extended waiting timer, the UE may decide (at 606) whether or not to perform autonomous denial. Not performing autonomous denial prior to expiration of the extended waiting timer is allowable since the wireless access network node is not expected to send an IDC solution prior to expiration of the extended waiting timer. The time duration of the extended waiting timer is depicted as 406 in FIG. 4.

Even though the UE does not have to perform autonomous denial, the UE may nevertheless perform autonomous denial during duration 406 (FIG. 4) to maintain a target wireless link quality.

The UE next determines (at 608) if the extended waiting timer has expired. If not, the process returns to task 606. If the extended waiting timer has expired, the UE can start (at 610) a second waiting timer. The second waiting timer, started in response to expiration of the extended waiting timer, can count at least part of the duration 408 depicted in FIG. 4.

In a first example, the second waiting timer can be an implementation-specific timer at the UE (different from the extended waiting timer). In a second example, the second waiting timer can be the same as the extended waiting timer, except that the extended waiting timer is restarted after expiration. The restarted extended waiting timer is the second waiting timer. The restarted extended waiting timer can use the same network-set value for the waiting time parameter received from the wireless access network node. The extended waiting timer can be restarted N number of times (where N≧1) to count the duration to wait for the IDC solution, where N can be configured by the wireless access network node or can be requested by the UE. The total duration of the extended waiting timer restarted N times can be considered the duration of the second waiting timer.

In a third example, the second waiting timer can be a second extended waiting timer, which can use another value of the waiting time parameter.

During the duration counted by the second waiting timer, the UE performs (at 612) autonomous denial. The UE determines (at 614) if an IDC solution has been received from the wireless access network node. If so, the UE applies (at 616) the IDC solution. On the other hand, if the IDC solution has not been received, the UE determines (at 618) if the second waiting timer has expired. If not, the process returns to task 612. However, if the second waiting timer has expired, then the UE performs (at 620) a remedial action due to failure to receive the IDC solution. The UE can declare an RLF and perform an RLF-related operation, which can include cell reselection. Alternatively, the UE can send another IDC indication to the wireless access network node.

RLF can be declared after expiration of an RLF timer, whose duration can include or not include the duration of the extended waiting timer and the second waiting timer, similar to that described in connection with FIG. 5.

Several different types of IDC solutions can be provided by the wireless access network node. For example, the IDC solution can include a Frequency Division Multiplexing (FDM) solution or a Time Division Multiplexing (TDM) solution. As other examples, the IDC solutions can further include a power control solution.

An FDM solution generally involves modifying the communication frequency of a particular radio interface in the UE to cause frequency separation between transmissions at a first radio interface and receptions at a second radio interface. Modifying the communication frequency of the particular radio interface can be accomplished by performing handover of a communications session of the particular radio interface from a first radio carrier (at a first frequency) to a second radio carrier (at a second, different frequency).

In some examples, to implement the FDM solution, the UE can inform the wireless access network node when transmission/reception of LTE or other radio signals would benefit or no longer benefit from the LTE radio interface of the UE not using certain carriers or frequency resources. With this approach, the UE indicates which frequency or frequencies are (or are not) useable due to IDC interference. The indication of which frequency or frequencies are (or are not) useable can be communicated in an IDC indication sent by the UE. The IDC indication sent by the UE to the wireless access network node can also include various frequency measurement information that can also be used by the wireless access network node to decide on the FDM solution to use.

A TDM solution generally involves modifying a time pattern associated with communication of a particular radio interface in the UE to cause time separation between transmissions at a first radio interface and receptions at a second radio interface. There can be several types of TDM solutions, including, as examples, the following: a TDM-DRX (Discontinuous Reception) solution, a TDM-HARQ (Hybrid Automatic Repeat Request) solution, and a TDM-gap solution.

With a TDM solution, the UE can send information regarding the IDC interference in an IDC indication, where the information can include the following example information: interferer type, mode, and appropriate offset in subframes. Based on the information, the wireless access network node can configure a TDM pattern for the TDM solution, where the TDM pattern specifies scheduling and unscheduled periods for communication of the UE. In some examples, the UE can suggest a TDM pattern in the IDC indication. In response to the suggested TDM pattern from the UE, the wireless access network node can decide on the final TDM pattern to use.

With a TDM-DRX solution, the UE can provide the wireless access network node with a desired TDM pattern. For example, the parameters related to the TDM pattern can include the following: (1) the periodicity of the TDM pattern, and (2) the scheduling period (or unscheduled period). It is up to the wireless access network node to decide and signal the final DRX configuration to the UE based on the UE suggested TDM pattern and other possible criteria (e.g. traffic type). The scheduling period corresponds to the active time of DRX operation, while unscheduled period corresponds to the inactive time.

With a TDM-HARQ solution, a number of LTE HARQ processes are reserved for LTE operation, and the remaining subframes are used to accommodate non-LTE (e.g. ISM or GNSS) traffic.

With the TDM-gap solution, the “gap” refers to a period during which the UE can perform measurements to obtain frequency measurement information (discussed further below) relating to the LTE radio interface in the UE. During each such gap, no uplink or downlink transmissions are scheduled. During the gap, the non-LTE radio interface can transmit and receive data.

A power control solution can be used to reduce power transmission at the UE to mitigate IDC interference. In some examples, the UE can report to the wireless access network node that power reduction is desired. In response, the wireless access network node can adjust the UE transmission power at one or more of the radio interfaces in the wireless access network node.

Although various IDC solutions are described above, it is noted that other IDC solutions can be used in other implementations.

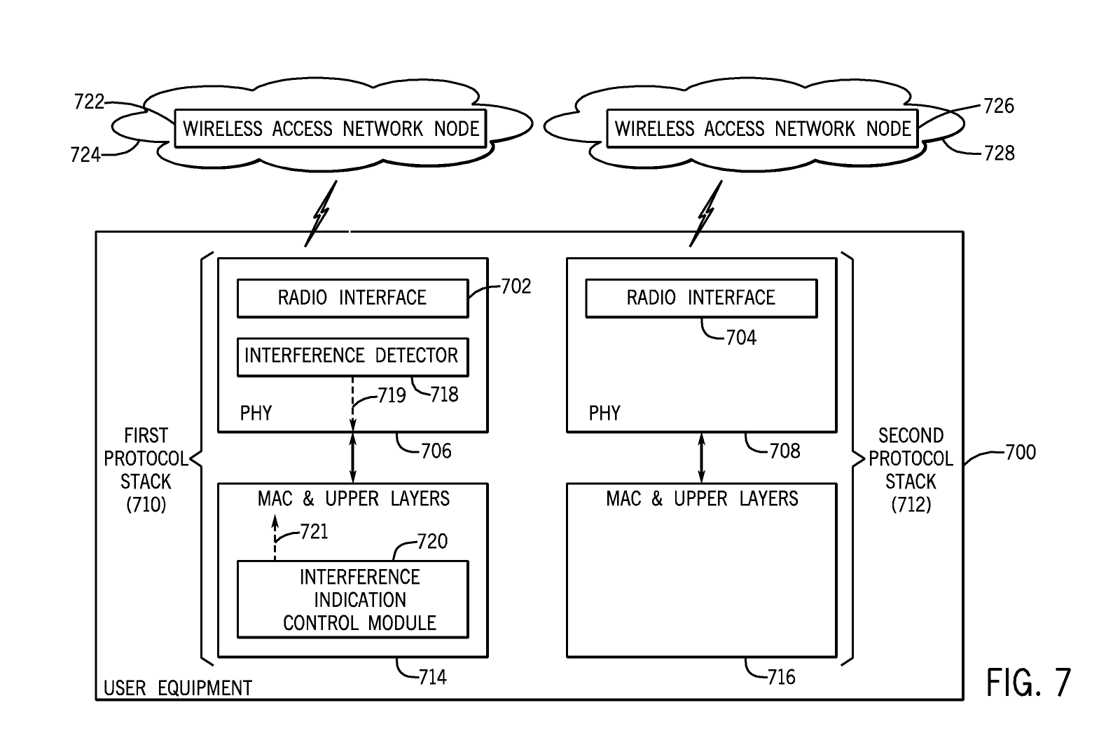

FIG. 7 is a block diagram of an example arrangement that includes a UE 700, which can be a mobile telephone, a smartphone, a personal digital assistant (PDA), a tablet computer, a notebook computer, or any other type of electronic device that is capable of performing wireless communications. In the example of FIG. 7, the UE 700 can include two different types of radio interfaces 702 and 704 that operate according to corresponding different wireless technologies. Although just two radio interfaces 702, 704 are depicted in FIG. 7, it is noted that in alternative examples, there can be more than two different types of radio interfaces in the UE 700.

The radio interface 702 is able to wirelessly communicate with a wireless access network node 722 in a wireless access network 724, and the radio interface 704 is able to wirelessly communicate with another wireless access network node 726 in a wireless access network 728. Each radio interface 702 or 704 can be a radio transceiver that includes a transmitter to transmit RF signals, and a receiver to receive RF signals.

The radio interfaces 702 and 704 are part of respective protocol stacks 710 and 712. The first and second protocol stacks 710 and 712 form a communication subsystem of the UE 700, to allow the UE 700 to communicate with various external entities.

The first protocol stack 710 can include protocol layers for a first wireless technology, while the second protocol stack 712 can include protocol layers for a second, different wireless technology. As examples, the first protocol stack 710 can operate according to the LTE technology, while the second protocol stack 712 can operate according to the ISM or GNSS technology.

In the foregoing example that includes an LTE protocol stack 710, the wireless access network node 722 can be an evolved node B (eNB) according to the LTE technology. An eNB can include functionalities of a base station and a radio network controller.

If the second protocol stack 712 operates according to the ISM technology, then the wireless access network node 726 in the wireless access network 728 can be a WiFi wireless access point, a Bluetooth master device, or some other type of wireless access point or base station. On the other hand, if the second protocol stack 712 operates according to the GNSS technology, then the wireless access network node 726 can be a satellite.

In the ensuing discussion, it is assumed that the first protocol stack 710 is an LTE protocol stack, and the wireless access network node 722 is an eNB. However, it is noted that techniques or mechanisms according to some implementations can be applied to other wireless technologies.

The LTE protocol stack 710 includes a physical layer 706 (that includes the radio interface 702) and higher layers 714 that include a medium access control (MAC) layer and upper layers. The physical layer 706 can be considered the lowest layer in the first protocol stack 710. The second protocol stack 712 includes a physical layer 708 (that includes the radio interface 704) and higher layers 716 that include a MAC layer and upper layers.

In accordance with some implementations, the radio interface 702, or another component in the physical layer 706, can derive the various feedback parameters relating to setting of an IDC interference threshold discussed above. These feedback parameters can be provided by the physical layer 706 to an upper layer 714 for transmission to the wireless access network node 722. In further implementations, the feedback parameters relating to setting of an IDC interference threshold can also be computed by the physical layer 706.

Generally, a MAC layer can provide addressing and channel access control mechanisms to allow the UE 700 to communicate over a shared medium, in this case a shared wireless medium. In some implementations, the upper layers of the LTE protocol stack 710 can include a Radio Resource Control (RRC) layer, as described in 3GPP Technical Specification (TS) TS 36.331. The upper layers can further include other protocol layers. The RRC protocol can define functionality associated with assignment, configuration, and release of radio resources between the UE 700 and the wireless access network node. Although reference is made to an RRC layer in the discussed examples, it is noted that in other examples, the upper layers can include alternative upper layers.

The upper layers that are included in the second protocol stack 712 depend on the wireless technology implemented by the second protocol stack 712.

As depicted in FIG. 7, the physical layer 706 further includes an interference detector 718. The interference detector 718 is able to detect IDC interference, such as IDC interference at a receiver of the radio interface 702 caused by transmission by a transmitter in the radio interface 704. In some examples, the interference detector 718 may also be able to detect IDC interference at a receiver of the radio interface 704 caused by transmission by a transmitter of the radio interface 702. In yet further examples, another interference detector (not shown) may also be provided in the physical layer 708 of the second protocol stack 712 to detect IDC interference at the receiver of the radio interface 704 caused by transmission by the transmitter of the radio interface 702.

Various techniques can be used for detecting IDC interference in a UE. Examples of several techniques are described in U.S. application Ser. No. 13/069,751, entitled “Method and Apparatus for Interference Identification on Configuration of LTE and BT,” filed Mar. 23, 2011.

In some examples, detection of IDC interference can be based on measurements at a radio receiver in the presence of transmissions from a radio transmitter. In alternative implementations, rather than performing detection of IDC interference based on measurements, IDC interference detection by the interference detector 718 can instead be based on internal coordination between the radio interfaces of the UE 700.

Upon detecting IDC interference and determining that the IDC interference satisfies one or more specified criteria, the interference detector 718 can activate an interference notification 719 that is provided to an interference indication control module 720. The interference indication control module 720 can be provided in one of the higher layers 714. In alternative examples, the interference indication control module 720 can also be provided in the physical layer 706.

The interference indication control module 720 can respond to the interference notification 719 from the interference detector 718 by generating an IDC indication 721 that is to be transmitted from the UE 700 to a corresponding wireless access network node.

In this discussion, although reference is made to the LTE protocol stack 710 sending an IDC indication to the wireless access network node, it is noted that in other implementations, the second protocol stack 712 can also include a mechanism to detect IDC interference and to send an IDC indication to the corresponding wireless access network node 726. Moreover, although reference is made to specific indications, messages, and procedures that may be according to the LTE technology, it is noted that in alternative implementations, techniques or mechanisms as discussed can be applied also to other technologies for handling of IDC interference between radio interfaces of a UE.

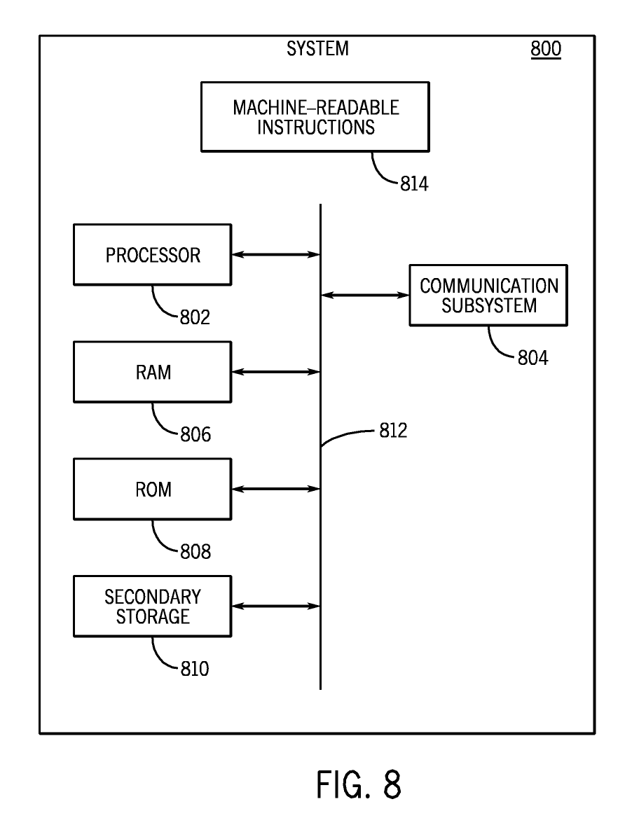

FIG. 8 illustrates an example system 800, which can either be the UE 700 or a wireless access network node, such as 722 or 726 in FIG. 7. The system 800 can include a processor (or multiple processors) 802. A processor can include a microprocessor, microcontroller, processor module or subsystem, programmable integrated circuit, programmable gate array, or another control or computing device.

The system 800 can include a communication subsystem 804 to communicate over a wireless link. The system 800 can also include various storage media, including a random access memory (RAM) 806 (e.g. dynamic RAM or static RAM), read-only memory (ROM) 808 (e.g. erasable and programmable read-only memory (EPROM), electrically erasable and programmable read-only memory (EEPROM), or flash memory), and secondary storage 810 (e.g. magnetic or optical disk-based storage), and so forth. The various components can communicate with each other over one or more buses 812.

Machine-readable instructions 814 in the system 800 are executable on the processor(s) 802 to perform various tasks discussed above, either in the UE 800 or in a wireless access network node. The machine-readable instructions 814 can be stored in any of the various storage media of the system 800.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a user equipment from a wireless access network node, a waiting time parameter indicating an amount of waiting time relating to provision, by the wireless access network node, of a solution for in-device coexistence (IDC) interference at the user equipment.

2. The method of claim 1, wherein the waiting time indicated by the waiting time parameter is a longest waiting time that the wireless access network node would take to provide the solution for the IDC interference.

3. The method of claim 1, wherein the waiting time indicated by the waiting time parameter is a shortest waiting time that the wireless access network node would take to provide the solution for the IDC interference.

4. The method of claim 1, further comprising:
performing, by the user equipment, autonomous denial during a time duration between receipt of the waiting time parameter and expiration of the waiting time, the autonomous denial including the user equipment ignoring uplink transmission from a first wireless interface to enable the user equipment to receive the solution for the IDC interference in downlink signaling at a second wireless interface.

5. The method of claim 1, further comprising:
performing uplink transmission at a first wireless interface and downlink reception at a second wireless interface during a time duration between receipt of the waiting time parameter and expiration of the waiting time.

6. The method of claim 1, further comprising:
sending, by the user equipment, an IDC indication to the wireless access network node, the IDC indication indicating presence of the IDC interference.

7. The method of claim 1, further comprising:
sending, by the user equipment to the wireless access network node, a suggestion of a waiting time for the waiting time parameter.

8. The method of claim 7, wherein the suggestion is sent in one selected from among a new uplink radio resource control (RRC) message, a new information element of an existing uplink RRC message, a physical level signature on a physical uplink control channel (PUCCH), a new uplink medium access control (MAC) control element, and a reservation field of an existing uplink MAC control element.

9. The method of claim 7, wherein the suggestion is sent in a new information element of an IDC indication message.

10. The method of claim 1, wherein receiving the waiting time parameter comprises receiving the waiting time parameter in one selected from among a new uplink radio resource control (RRC) message, a new information element of an existing uplink RRC message, a new uplink medium access control (MAC) control element, and a reservation field of an existing uplink MAC control element.

11. The method of claim 1, wherein the waiting time parameter is a configurable parameter based on at least one condition at the wireless access network node.

12. The method of claim 1, wherein the waiting time parameter is a fixed parameter.

13. The method of claim 1, further comprising:
receiving, by the user equipment from the wireless access network node, another instance of the waiting time parameter set to a specified value, wherein the specified value indicates that the wireless access network node has rejected providing a solution for IDC interference.

14. The method of claim 1, further comprising receiving, by the user equipment, an update of a value for the waiting time parameter.

15. A user equipment comprising:
a communication interface configured to communicate wirelessly with a wireless access network node; and
at least one processor configured to:
receive, from the wireless access network node, a waiting time parameter indicating an amount of waiting time relating to provision, by the wireless access network node, of a solution for in-device coexistence (IDC) interference at the user equipment.

16. The user equipment of claim 15, wherein the at least one processor is configured to start a waiting timer based on a value of the waiting time parameter.

17. The user equipment of claim 16, wherein upon expiration of the waiting timer without receiving the solution for the IDC interference, the at least one processor is configured to perform a remedial action.

18. The user equipment of claim 17, wherein the remedial action includes declaring a radio link failure and performing an operation relating to the radio link failure.

19. The user equipment of claim 18, wherein the at least one processor is configured to declare the radio link failure upon expiration of a radio link failure timer.

20. The user equipment of claim 19, wherein the at least one processor is configured to receive, from the wireless access network node, information relating to whether or not a duration of the waiting timer is included in a duration of the radio link failure timer.

21. The user equipment of claim 17, wherein the remedial action includes sending an IDC indication to the wireless access network node.

22. The user equipment of claim 16, wherein the waiting timer is a first waiting timer, and wherein the at least one processor is configured to:
start a second waiting timer upon expiration of the first waiting timer, and
wait for the solution to the IDC interference during a duration of the second waiting timer.

23. The user equipment of claim 22, the second waiting timer is one selected from among an implementation-specific timer, a restarted instance of the first waiting timer, and another first waiting timer.

24. A wireless access network node comprising:
a communication interface configured to communicate wirelessly with a user equipment; and
at least one processor configured to:
send a waiting time parameter to the user equipment, the waiting time parameter indicating an amount of waiting time relating to provision, by the wireless access network node, of a solution for in-device coexistence (IDC) interference at the user equipment.

25. The wireless access network node of claim 24, wherein the at least one processor is configured to further:
receive, from the user equipment, a suggested value for the waiting time parameter,
wherein the amount of waiting time indicated by the waiting time parameter sent to the user equipment is identical to or different from the suggested value.

26. A method comprising:
starting a waiting timer in a user equipment, wherein the waiting timer is configured to count a duration relating to an amount of time for a wireless access network node to provision a solution for in-device coexistence (IDC) interference at the user equipment, wherein the amount of time is specified according to a wireless standard.
